(19) United States
(12) Patent Application Publication
(10) Pub. No.: US 2014/0237035 A1
(43) Pub. Date: Aug. 21, 2014

(54) PROCESS FOR ASSISTING IN THE DESIGN OF ROOM LAYOUTS

(71) Applicant: SCHEMATIC LTD, Linlithgow, West Lothian (GB)

(72) Inventors: Joseph Smith, Linlithgow (GB); Stewart Miller, Linlithgow (GB)

(73) Assignee: Schematic Ltd., Linlithgow (GB)

(21) Appl. No.: 14/346,265

(22) PCT Filed: Sep. 20, 2012
(86) PCT No.: PCT/GB2012/052331

§ 371 Date: Mar. 20, 2014

(30) Foreign Application Priority Data
Sep. 20, 2011 (GB) 1116238.5

(51) Int. Cl. H04L 29/08

(52) U.S. Cl. CPC H04L 67/10
USPC 709/203

(57) ABSTRACT

A system comprising means for communicating information relating to relevant products and services from a server to a user interface, means for enabling a user to arrange relevant products and services on a screen within user-defined parameters, means for communicating the arrangement to the server, means for processing the arrangement into one of more specifications and means for communicating desired specifications from the server to the user interface.

### INTRODUCTION

The present invention relates to a method for the design and display of room layouts, especially for space planning.

Previously proposed processes for the design of room layouts involve laborious manual conversion and interaction of many sets of information from various sources in order to progress from an idea which is held only in the designer's “mind's eye” to, for example, a three-dimensional (3d) representation of the design and a list of items to be procured.

It is an aim of the present invention to provide an interface between several aspects of the design process and providing translation of information between various information input and output means.

The present invention relates to a system to make it easy for users to create designs using real life manufacturer's products. The present invention will be targeted at the Catering Equipment Sector. This is only one of the many sectors the present invention could be applied to and is not limited in its capability for any type of Space Planning use. The present invention may use Java and OpenGL for portability over various Operating Systems. The present invention will also interface with CAD applications, spreadsheet and word processor software for the exchange of drawing and estimate data.

Accordingly, a first aspect of the present invention is directed to a system comprising means for communicating information relating to relevant products and services from a server to a user interface, means for enabling a user to arrange relevant products and services on a screen within user-defined parameters, means for communicating the arrangement to the server, means for processing the arrangement into one of more specifications and means for communicating desired specifications from the server to the user interface.

This arrangement has the advantage of enabling the various stages of design to be carried out on the most suitable platform. For example the graphical design stage may be carried out via a browser or application on a portable computer or telephone while the calculations and data storage can be on a remote server with more appropriate processing power and direct access to the required databases. The required databases may also be kept current in a single location, reducing the burden of distribution of data to the “client” computer or telephone.

The means for the required functions may be a web front end and database using technology from MySQL, HTML, JavaScript, CSS and PHP programming. The web front end holds and displays manufacturer information as a standalone website and also provides a gateway within the present invention for access to database information allowing functions to be executed using drag and drop functionality within the application via a web browser in the programme.

Accordingly, a second aspect of the present invention is a plug-in module for the present invention. Using a library of components from the first aspect's database, users will be able to construct bespoke models and drawings for use in their project using the same method of drag and drop functionality as already mentioned.

Accordingly, a third aspect of the present invention is another plug-in module. This is a locally stored database of the users' customer contact details holding information like address details etc. Users will also be able to place orders directly with manufacturers using this module and is envisaged to communicate with third party accountancy and invoicing software.

Accordingly, a fourth aspect of the present invention is an integration to the first aspect. This provides detailed information specific to the users industry on best practice for design and planning in there sector. This will be in the form of PDF downloads and searchable database information in a categorised fashion.

Accordingly, a fifth aspect of the present invention is a further module integrated into the first aspect's website and database. This will be a searchable library of “Off the Shelf” design solutions which users will be able to drag and drop from the first aspect in the same way as already mentioned.

Accordingly, a sixth aspect of the present invention is also integrated into the first aspect. This will provide an industry directory of contact information like Engineers, Installers and Manufacturers.

### SUMMARY

The present invention relates to a vector graphic computer aided drawing system. It uses lines, curves and primitive objects in 2d and 3d based on mathematical equations and points in a space to display images on a computer screen. The system may be implemented in the Java programming language and may also use OpenGL bindings for Java to process vector graphic data.

A user of the system according to the present invention can then start a new project in one of three alternative ways:

i. a vector graphic file in the .dxf file format can be imported into system from a host of CAD software programs. The .dxf file is made up of co-ordinates and points in a mathematical format. The system reads these co-ordinates and points and re arranges them to display vector graphics on the hardware's display. At this point the document can be saved in a suitable file format which holds mathematical equations and data to recall the co-ordinates and points if opened again in the present system. This forms the basis of a drawing template named “Imported Plan” and is assigned to a layering system in the system with names the same as in other CAD applications. The user can then start drawing Walls using the “Imported Plan” template;

ii. the user can start a project from scratch by using a Floor Tool or a Wall Tool to insert dimension information from survey notes. This will achieve the same visual results as tracing an “Imported Plan” and will allow the project to be saved with the relevant co-ordinate and point data for recall on opening of the file after it has been saved; or

iii. the user can use the first aspect of the present invention to create a list of equipment from the database essentially creating a quote/estimate. As this is compiled, the corresponding “Drawing Blocks” are held in the computer's memory. This would allow the user to create a drawing using the stored “Drawing Blocks” to create a design with the items in the Quote/Estimate already compiled.

Once any of the three methods above have been completed, the user will essentially have completed a 2d drawing, quote, services schedule and 3d drawing. The user at this point has the option to render the 3d drawing to high quality using the built in rendering engine to create photo real images or videos. All of the elements at this point can be copied to a master layout showing equipment lists, 2d drawings, 3d drawings etc on a single sheet ready for printing. Printing supports any size of paper and interfaces with any network or locally connected printers. Alternatively, users can print to PDF format for electronic transmission or export elements for opening within applications such as word processors or spread sheet editors.

The final option in relation to the design stage is the option to be able to export the 2d drawing back to .dxf file. This means that when the user receives the e.g. Architects drawing file, he can produce the layouts using the present invention after the import procedure, complete the layout and export back the to .dxf file format. This means the architect can incorporate any designs created using the present invention within the master plan on any design system which supports .dxf.

### TECHNICAL DESCRIPTIONS

### Tools

The present invention will further comprise other standard features found in modern computer-based systems:

Line Tool—Click once to start line, click again anywhere to end. User input method will be ether by snapping to end points or mid points at start or finish of line execution or by pressing the enter button on a keyboard to set the distance, press tab again to set the angle.

Polyline Tool—the same as the line tool except when a line has ended, a new line is joined and started to the end point of the previous line drawn.

Circle Tool—Click once to start circle from centre point. Mouse is dragged to set diameter/radius. Press enter once to set diameter/radius manually then enter to finish. Can also be snapped to end points and mid points in other objects.

Arc—Same method as circle.

Spline tool—No user input, this exists only to provide full support of the .dxf file import.

Wall tool—The wall tool is primarily made up of a 2d poly line shown in the 2d viewport. This poly line will also hold additional co-ordinate information taken from user preferences which will be gathered with the 2d points to create a 3d preview generated in real time. The user input will be the same as how the poly line tool works and will snap to all available mid points, and end points.

Floor Tool—the floor tool will work in the same way as the poly line tool and will be used to create a 2d plane in the 2d viewport. These co-ordinates will also be translated to the 3d view to display a flat plane making up floors. Users can also set a ceiling height which in essence will copy the floor automatically and set it directly above the floor at the user designated height.

Object Group—All items in the 2d viewport can be selected and made into a group. This makes for easier editing and movement of objects in relation to items within a particular group.

Layering system—The user can set any group, object, item, line, circle etc to a certain layer in the drawing system. This allows for users to select if a particular layer is visible or not for example, editability can also be locked so as to protect parts of the working drawing from being edited.

Scale Tool—Users will be able to select a specific grouped object, wall and anything in the 2d drawing viewport and affect its size or scale by picking this tool.

Draw order—Users can select any item or group in the 2d drawing environment and decide whether it is shown above or below an item in the same location on the 2d plan. This could be a shelf above a radiator for example. Selecting the shelve to be shown above would hide part of the radiator.

Text input—This will allow for drawing notes to be inserted directly into the 2d drawing.

Text editing tools—Users can affect the Text Input style. Includes Fonts Type, Text Size, Bold, Italic and underline.

Dimensions—Users can select the dimensions tool to click between any 2 points in the 2d viewport to create a measurement shown on the drawing.

Auto Numbering tool—This will take the text input tool and sequentially input numbers for any items in the 2d drawing view port to be automatically assigned a number by clicking them in a desired order.

Undo/Redo—unlimited undo and redo functionality for all tools in the software program.

Save/Save As—Allows the user to save all data in the current project to a suitable file format.

Navigation 2d—The user can Pan the drawing with the Pan tool and zoom in and out using the zoom in tool or the zoom out tool or by rolling the mouse wheel back or forth.

Navigation 3d—the user can left click anywhere in the 3d view and move the mouse to adjust the camera view in 3d. The user can roil the mouse wheel back or forth to adjust the camera back or forth. In preview mode, the user can use the mouse as described, but can also use the arrow keys on the keyboard to move back and forth or side to side.

Materials—Users can double click any object in the 2d view to inspect the properties of the object. The user can also apply new materials or a colour. This is then updated in the 3d view port in real time.

3D Rendering—This may be done using any suitable rendering engine, such as an open source Java Render Engine “Sunflow”. The 3d view may be exported by taking the 3d Co-ordinates and transporting them to the render engine with material co-ordinates and sizes. The render engine may then Ray Trace the 3d model at the selected camera angle to produce a photo realistic image. The user can also create a video by selecting multiple camera angles and the exported camera co-ordinates will automatically create transitions between each camera location. The output result of this is a fly through video presentation.

### Modules

This covers the main processes required to put into effect the several aspects of the present invention.

The first aspect of the present invention is, as described above, a database with a web front end. The web front end will be displayed in a browser. Users will be able to search through the database using this aspect of the invention and select items from specific manufacturers, organise search results be order of price or any other attribute stored in the database. Once the user has a desired result, the display page will show an image and detailed information about the item. If the item has optional extras provided by that manufacturer, the user can tick the optional extras and this will update the price and any other information like height for example if factory fitted castors are added or removed.

Once this process is complete, the user can then add the item to the current project. The user will simply click add, or click and drag from anywhere on the screen into the 2d view or the spreadsheet tab. If the user adds to the 2d plan, the 2d block of that item is displayed there. Subsequently in real time the text data like price or description is downloaded in real time as is any attached files like maintenance manuals etc and also the 3d model information. The text data is displayed in the spreadsheet tab and the 3d model information in the 3d view. It the item is moved from one place to another in the 2d viewport, this is automatically updated in the 3d view and shown in the correct location within 3d space.

The second aspect of the present invention is a library of components within the a database. These components can be used to construct bespoke items and models for use in the current project. Once an item has been created, it can then be stored locally on the user's machine for use in future projects. Items created during this procedure need the user to manual input information into the spreadsheet tab, as they are bespoke and do not exist in the database of the first aspect of the invention.

The fourth aspect of the present invention is a menu option within the first aspect of the invention. The principle is that the user can use the fourth aspect to search for information on Design and implementation relative to their industry. This will be in the form of an electronic “ebook” and searchable database with topical search criteria for any given element.

The sixth aspect of the present invention is a searchable directory of professionals relative to the industry. For example manufacturers' address details or repair engineers' contact details. The database will be searchable via postal code or area, which can be refined by any information held in the database for any entry of information.

Spreadsheet tab—This module will display information gathered by the first aspect of the invention for compiling quotes and estimates or services schedules and Operating Manuals and maintenance Manuals. The layout will consist of rows and columns and will show all information held about a selected item to the user by default. The user can then select from templates what type of document they want to produce. If a quote template is selected, this might only show who the manufacturer is, a description, the quantity and the price. This can then be saved within the project and another document stared, it can be printed, saved as a PDF or exported to the .xml format for use in other office applications.

If the user wishes then to create a Services schedule they can select a template relative to requirements, or simply hide and show columns to display their desired information in any order they wish. As all this information is held in the database and downloaded to the local system, this happens instantly and the user does not have to wait. If the user wishes to, the present invention may create an O&M manual from all the items in the project once a quote, estimate or services schedule has been complete by simply clicking a button. This takes the PDF manuals previously downloaded from the database and compiles them into one single PDF document ready to print or save electronically for transmission via email, or save to disk. Once spreadsheets have been completed they can be printed as single documents, or the user can click and drag them the main 2d layout so they can be printed on the same sheet as the 2d and 3d drawing on large scale paper layouts.

If the user re-opens a project after some length of time, it may be that an item selected might be discontinued from that manufacturer, or a price increase has occurred. The present invention will produce a warning message and the user will be presented with an option to update any outdated information if the so wish. As alternative way of operation, the user can drag items directly from any aspect of the present invention and drop them into the Spreadsheet. This is a way of being able to compile a quote, service schedule or any other document. When this happens, the symbols for 2d and 3d views are stored to computer memory and are place in the project symbols bin. Once the quote is complete, the user can drag the corresponding 2d symbol from the symbols bin into the 2d viewport which in turn adds the 3d symbols.

3D Viewport—The 3d view may be directly linked to the 2d View and any aspect of the present invention. When an item is added to the 2d viewport from any aspect of the present invention, or drawn in by use of either the floor tool or the wall tool. The 3d model information or co-ordinates are automatically transformed into 3d and shown in the 3d view. If an item is edited in the 2d view or is moved from one location to another, this information is also automatically updated in real time in the 3d view.

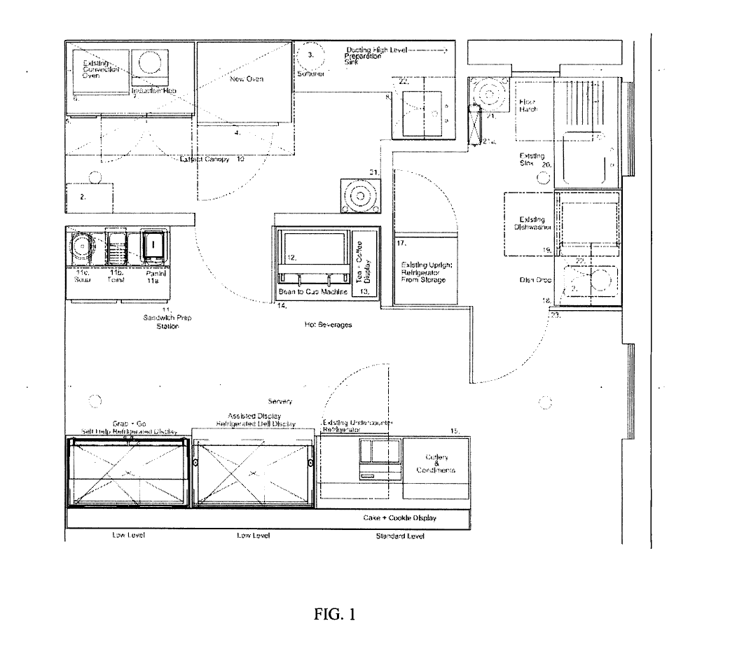

An example of how an embodiment of the present invention may be represented to a user is now described with reference to FIGS. 1 to 8.

FIG. 1 shows a room layout arranged as a floor plan in a schematic style. The user may arrange items within a representation of a room with certain parameters via a graphical interface.

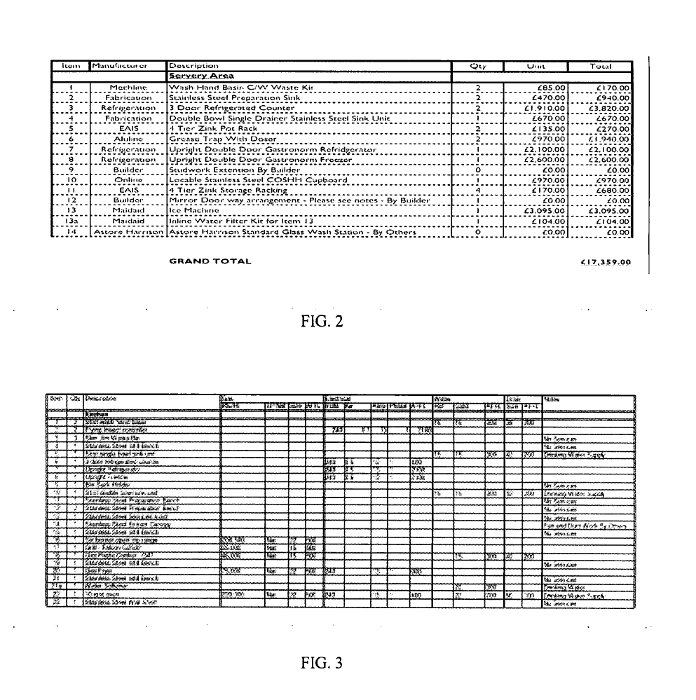

FIG. 2 shows in list form items which may be available to the user to arrange within the room layout. The list comprises technical and non-technical descriptors and definitions.

FIG. 3 shows in list form service requirements for items which may be available to the user to arrange within the room layout.

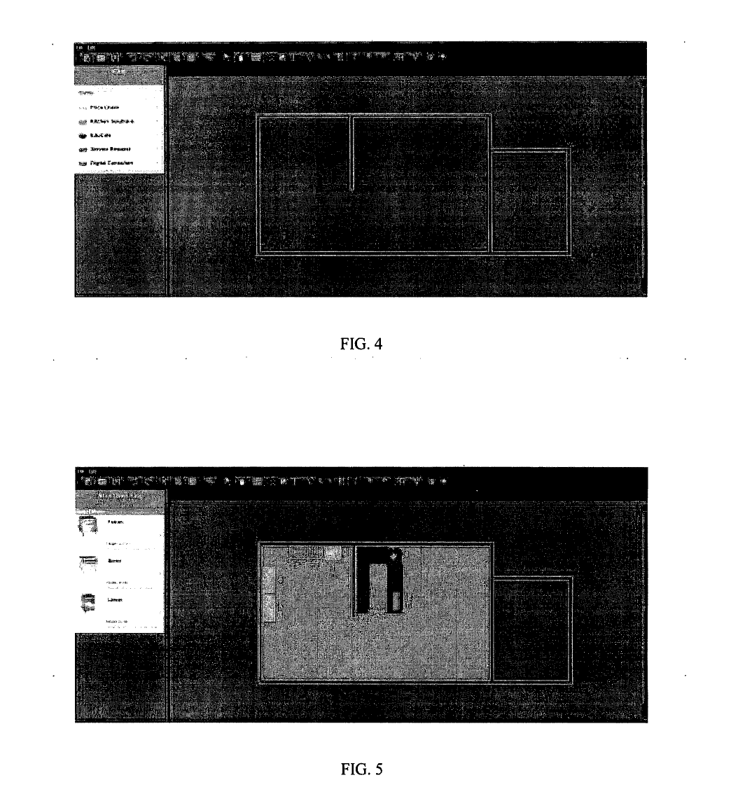

FIG. 4 shows an example of how the aspect of the invention relating to the graphical selection and arrangement of items within the parameters of a room may appear to the user in two-dimensional mode.

FIG. 5 shows an example of how the aspect of the invention relating to the graphical selection and arrangement of items within the parameters of a room—with items already arranged within the room—may appear to the user in two-dimensional mode.

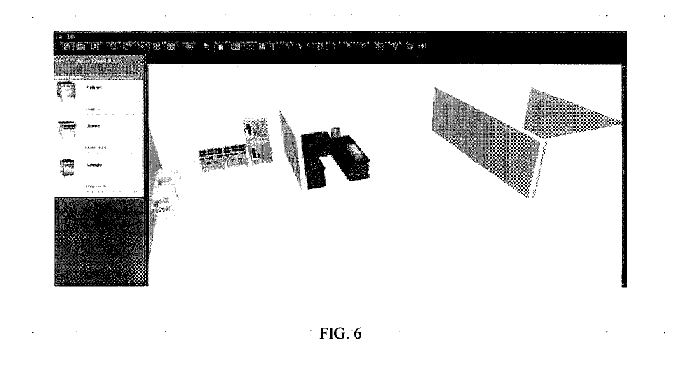

FIG. 6 shows an example of how the aspect of the invention relating to the graphical selection and arrangement of items within the parameters of a room—with items already arranged within the room—may appear to the user in three-dimensional mode.

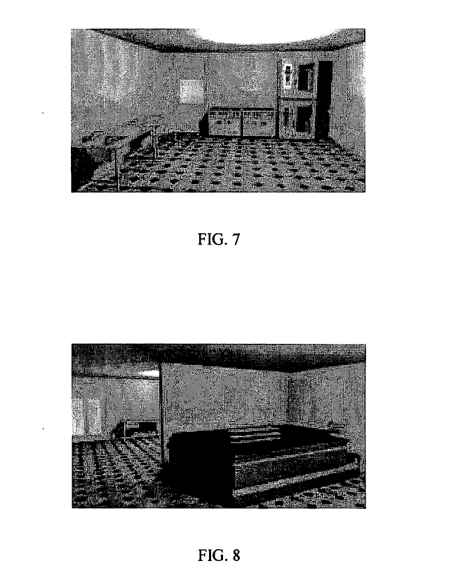

FIGS. 7 and 8 show an example of how the aspect of the invention relating to the graphical rendition of a substantially completed design may appear to the user in three-dimensional mode.

1. A system comprising means for communicating information relating to relevant products and services from a server to a user interface, means for enabling a user to arrange relevant products and services on a screen within user-defined parameters, means for communicating the arrangement to the server, means for processing the arrangement into one of more specifications and means for communicating desired specifications from the server to the user interface.

2. A plug-in module for use with a system according to claim 1, wherein users are be able to construct bespoke models and drawings for use in their project using the method of drag and drop functionality.

3. A plug-in module for use with a system according to claim 1, comprising a locally stored database of the users' customer contact details holding information like address details etc., wherein users are able to place orders directly with manufacturers using this module and to communicate with third party accountancy and invoicing software.

4. A plug-in module for use with a system according to claim 1, which provides detailed information specific to the users industry on best practice for design and planning in there sector, in the form of PDF downloads or searchable database information in a categorised fashion.

5. A plug-in module for use with a system according to claim 1, which provides a searchable library of “Off the Shelf” design solutions which users will be able to drag and drop from the system according to claim 1.

6. A plug-in module for use with a system according to claim 1, which provides an industry directory of contact information like Engineers, Installers and Manufacturers.
